(19) United States
(12) Patent Application Publication
(10) Pub. No.: US 2019/0063636 A1
(43) Pub. Date: Feb. 28, 2019

(54) DEVICE AND SYSTEM FOR PREVENTING UNAUTHORIZED ACCESS TO A GAS- CONTAINING SYSTEM

(71) Applicant: Michael Raymond SEARS, Caddo Mills, TX (US)

(72) Inventor: Michael Raymond SEARS, Caddo Mills, TX (US)

(21) Appl. No.: 16/108,510

(22) Filed: Aug. 22, 2018

Related U.S. Application Data
(60) Provisional application No. 62/605,784, filed on Aug. 28, 2017.

(51) Int. Cl. F16K 35/10; F16B 41/00; F16L 55/115

(52) U.S. Cl. CPC F16K 35/10; F16L 55/1152; F16B 41/005

(57) ABSTRACT

A system for preventing unauthorized access to a gas in which the system has a gas conduit, a cap affixed to an end of the gas conduit, a pipe positioned over the cap and over a portion of the gas conduit, and a set screw threadedly secured in a threaded hole of the pipe so that the set screw has an end bearing against the gas conduit. The pipe has an end that extends outwardly beyond an end of the cap. The pipe has an inspection hole formed diametrically opposite the threaded hole. The set screw has a unique tool-receiving slot at an outer end thereof. This unique tool-receiving slot is adapted to receive a special tool therein for the attachment or removal of the pipe from the gas conduit.

### CROSS-REFERENCE TO RELATED APPLICATIONS

The present application claims priority from U.S. Provisional Patent Application Ser. No. 62/605,784, filed Aug. 28, 2017 and entitled “Freon Valve Lock”.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to devices that prevent unauthorized access to a gas conduit. More particularly, the present invention relates to locking systems that prevent unauthorized individuals from obtaining gas from a gas system, such as a refrigeration or an air-conditioning system.

### 2. Description of Related Art Including Information Disclosed Under 37 CFR 1.97 and 37 CFR 1.98

Closed mechanical systems containing gaseous or liquid substances often have access points or ports for accessing the gaseous or liquid substances therein and/or for servicing the system. For example, pressurized tire and wheel assemblies often use a valve stem for deflating and inflating the tire. Likewise, refrigeration and air-conditioning systems often employ a similar valve system which provides access to the refrigerant compound for purposes of servicing the refrigerant. The valves are known in the art as refrigeration access valves.

Refrigeration access valves can be accessed by removing or unscrewing the cap from the threaded and cylindrical end of the valve. Such valve caps serve to cover and protect the center pin of the refrigeration access valve from damage, but do not prevent unauthorized access to the valve. Once the cap is removed from the valve, the gaseous or liquid compound contained within the closed system can be accessed by manipulating the pin in the refrigeration access valve.

For purposes of safety and security, there is a need for a tamper-proof cap for refrigeration access valves and the like to prevent unauthorized access to the contents of the mechanical system to which the valve is engaged. For example, refrigerant compounds containing hydrochlorofluorocarbons, commonly referred to by the trade name FREON™, can be extremely toxic to human beings and animals if inhaled. Unfortunately, a trend has emerged for people, particularly young people, to intentionally ingest, sniff, or inhale FREON™ in an attempt to get high. The trend has been known as “FREON™ huffing”. Inhalation of FREON™) is extremely dangerous and can cause extreme medical complications, including death. People intent on inhaling FREON™ can easily access the compound through refrigeration access valves on refrigeration and air-conditioning systems. Even young adults and adolescents can readily remove a standard cap from a refrigeration access valve and gain access to FREON™ in a refrigeration and air-conditioning system.

Under certain circumstances, when persons attempt to obtain an unauthorized access to the contents of such refrigeration and air-conditioning systems, they can damage the important connection components for the access valve. As such, a need has developed for systems and devices for securing valves, such as refrigeration access valves, to prevent unauthorized access to the contents of the mechanical system to which the valve is engaged. A need exists for a tamper-proof cap or associated assemblies and systems, that are usable with existing refrigeration access valves and which prevents or deters unauthorized access thereto.

In the past, various patents have issued with respect to techniques for restricting access to such systems. For example, U.S. Pat. No. 4,630,456, issued on Dec. 23, 1986 to A. J. Nielsen, describes a casket lock for a valve assembly. This casket lock includes a pair of mating casket sections releasably connected together along a hinge about which the sections are movable between open and closed positions. In the closed position, the casket sections cooperate to define a casket containing the valve and the conduit connections thereto. The casket sections are releasably retained in a closed position by a fastener contained within the casket. A tubular lock is secured in a locked position to the casket so as to prevent access to the fastener.

U.S. Pat. No. 4,777,811, issued on Oct. 18, 1988 to Binkley, describes a clamshell security device for placement over a valve so as to prevent unauthorized access to the valve. The housing includes first and second shell halves. The first and second shell halves are matable to form an enclosure for the valve and form openings through which the line can pass. Each shell half includes a perimetral lip region, an interior surface, and an exterior surface. A lock-receiving bracket is attached to the interior surface of the first shell. The lock-receiving bracket includes an aperture through which a bolt-type lock can pass. A lock-engaging member is attached to the interior surface of the second shell half.

U.S. Pat. No. 6,209,574, issued on Apr. 3, 2001 to T. J. Prewitt, describes a FREON™ lockbox. This lockbox may be opened, positioned around the gauge ports on the refrigerant lines and air-conditioning system and then locked and closed. This prevents unauthorized access to the gauge ports and bleed-off of the refrigerant from the ports.

U.S. Pat. No. 7,004,701, issued on Feb. 28, 2006 to W. K. Ross, teaches a tamper-resistant rotatably-shrouded security cap and tool for preventing unauthorized access to a fluid handling system. The shroud and cap have cooperating engagement means that allow the shroud to rotate freely about the security cap, such that a grip on the shroud will not turn the cap. The cap is provided with a grip-resistant upper surface to discourage gripping with compression-type tools, such as pliers. The cap is recessed within the shroud to make unauthorized access more difficult and is provided with a wide range of non-standard keyway-type tool fittings. The shroud and cap system can be configured as a cap, a plug, a valve stem, among other variations.

U.S. Patent Application Publication No. 2013/0160503, published on Jun. 27, 2013 to Martinelli et al., discloses an apparatus and method for restricting access to a gas source. This is a locking cap system that is useful for controlling access to a gaseous system. The locking cap system includes an outer lock, an inner lock, a metallic key and a magnetic opener. The inner lock rotates freely relative to the outer cap and is releasably engaged with the gaseous system. The metallic key is configured to be at least partially axially movable within the inner lock and the outer cap. The magnetic opener is used to bias the metallic key so that the metallic key engages the inner lock and the outer lock simultaneously to allow the inner lock to rotate concurrently with rotation of the outer cap and engage or disengage from the gaseous system.

U.S. Patent Application Publication No. 2014/0157840, published on Jun. 12, 2014 to Martinelli et al., teaches a cap lock system for limiting access to an access port of a gaseous system. This cap lock system includes an outer cap having first and second key insertion passages, and interlock having first and second key receivers, and a rotatable key having first and second engagement fingers that are each engageable with an aligned set of key insertion passages and key receivers.

It is an object of the present invention to provide a device and system that prevents unauthorized access to a gas within a refrigerant or air-conditioning system.

It is another object of the present invention to provide a device and system that avoids the health issues associated with the huffing of gases from such systems.

It is another object of the present invention to provide a device and system that is easy to manufacture, easy to use and relatively inexpensive.

It is a further object of the present invention to provide a device and system that reduces liability to the owners of refrigerant or air-conditioning systems.

It is still another object of the present invention to provide a gas and system that avoids damage to the gas valves that could be caused by the unauthorized access or the use of tools to gain such unauthorized access.

These and other objects and advantages of the present invention will become apparent from a reading of the attached specification and appended claims.

### BRIEF SUMMARY OF THE INVENTION

The present invention is a system for preventing of unauthorized access to a gas in a gas-containing system. The system comprises a gas conduit, a cap affixed to an end of the gas conduit, a pipe positioned over the cap and over a portion of the gas conduit, and a set screw threadedly secured within a threaded hole of the pipe. The set screw has an end bearing against the gas conduit. The outer end of the set screw is flush with an outer diameter of the pipe or located inwardly of the outer diameter of the pipe.

The cap has an outer diameter greater than an outer diameter of the gas conduit. The cap has an inner diameter slightly greater than the outer diameter of the cap. The pipe has an end that extends outwardly beyond an end of the cap opposite the gas conduit. The pipe also has an inspection hole formed through the wall of the pipe. This inspection hole is diametrically opposite to the threaded hole. The inspection hole is unthreaded.

The set screw has a tool-receiving slot formed at an end thereof opposite the end that bears against the gas conduit. This tool-receiving slot has a center pin that prohibits the use of an Allen wrench therein. In a specific embodiment of the present invention, the tool-receiving slot has a circular area with a plurality of rectilinear areas projecting radially outwardly of the circular area. In a specific form of the present invention, each of the plurality of rectilinear areas is of a generally square shape. The plurality of rectilinear areas are three in number and spaced from each other by approximately 120°. A wide variety of other tool-receiving slot configurations could also be used.

The pipe and the set screw are of a stainless steel material. The pipe should have a thickness that properly supports the set screw.

The present invention is also a device for preventing unauthorized access to a gas n a refrigerant or air-conditioning system. This device comprises a pipe having a wall and on interior passageway in which the interior passageway is adapted to extend over the cap and a portion of the gas conduit, and a set screw threadedly received in a threaded hole of the pipe. The set screw is rotatable within the threaded hole and adapted so as to have an inner end that extends inwardly into the interior passageway of the pipe.

The pipe has an inspection hole formed through the wall of the pipe. This inspection hole communicates with the interior passageway of the pipe. The pipe is open-ended. The set screw has a tool-receiving slot at an outer end thereof. This tool-receiving slot has a center pin that prohibits the use of an Allen wrench therein.

In the present invention, the pipe is placed over the cap and a portion of the conduit of the gas-containing system. As the pipe is applied, the set screw is in a retracted position so as to not interfere with the sliding of the pipe over the cap and the portion of the conduit. In this retracted position, the inner and of the set screw will be flush with an inner diameter of the pipe or recessed inwardly of the threaded hole away from the interior passageway of the pipe. After the pipe is placed over the cap and a portion of the conduit, the set screw is tightened so as to move downwardly and to bear against the gas conduit. The outer end of the set screws should be flush with the outer diameter of the pipe or inwardly of the outer diameter of the pipe. An opposite end of the pipe will extend outwardly beyond the end of the cap opposite the gas conduit. In this configuration, it is impossible for a user to unscrew the cap from the gas-containing system or otherwise tamper with the cap so as to gain access to the gas therein. When it is necessary to recharge the system with a gas, the set screw can be unscrewed and the pipe pulled outwardly from the conduit and the pipe. The cap can then be unscrewed so as to gain access to the Schrader valve.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is perspective and exploded view of the system of the present invention as applied over the access port of a gas-containing system.

FIG. 2 is an upper perspective view showing the pipe as used in the system of the present invention.

FIG. 3 is a cross-sectional view showing the application of the system of the present invention on to the gas-containing system.

FIG. 4 illustrates the set screw of the present invention.

FIG. 5 is an end view of the pipe of the present invention showing the set screw as extending through the wall of the pipe.

FIG. 6 is an end view of the set screw and showing, in particular, the special configuration of the tool-receiving slot.

### DETAILED DESCRIPTION OF THE INVENTION

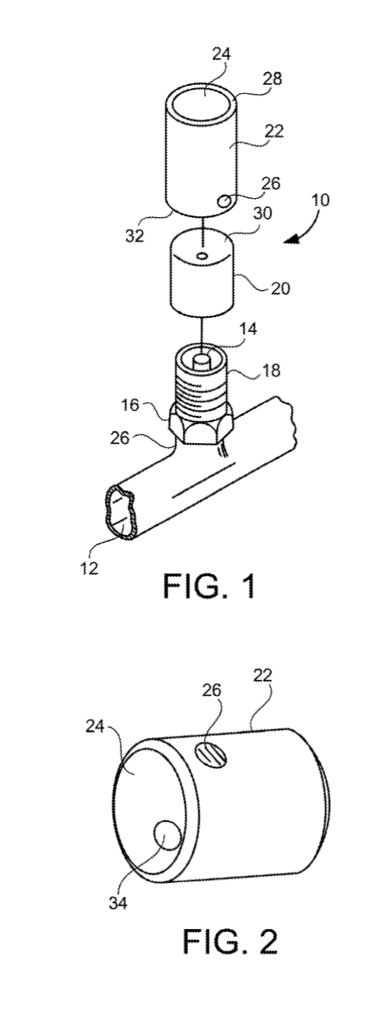

Referring to referring to FIG. 1, there shown the system 10 for preventing unauthorized access to a gaseous or liquid-containing system. It can be seen that there is a conduit 12 which allows for the passing of the gas or liquid therethrough as part of a refrigerant or air-conditioning system. A Schrader valve 14 allows access to the conduit 12. It can be seen that the Schrader valve 14 is part of a T-connection 16. The Schrader valve 14 has a externally threaded section 18 around the periphery thereof. This externally-threaded section prevents damage to the Schrader valve 14 when the system is charged with a gas or liquid. During the step of charging, a source of a gas or a liquid is placed in the fluid connection through the use of the Schrader valve 14 so that a flow is established into the refrigerant or air-conditioning system. After the system is charged, a cap 20 is threadedly secured over the externally-threaded section 14 of the Schrader valve 14.

The present invention includes a pipe 22 that is placed over the cap 20 and a portion of the conduit 12. The pipe 22 will have an interior passageway 24 having a diameter greater than the outer diameter of the cap 20 and greater than an outer diameter of a portion 26 of the refrigerant or air-conditioning system. There is a threaded hole 26 that opens through the wall of the pipe 22. Threaded hole 26 will allow a set screw to be rotatably mounted therein so as to allow the pipe 22 to be affixed in position over the cap 20 and the portion 26 of the refrigerant or air-containing passing system.

The pipe 22 can be formed of a stainless steel material. Ultimately, an end 28 of the pipe 22 should have a length so as to extend outwardly beyond the end 30 of the cap 20. The opposite end 32 of the pipe 22 will extend over the portion 26 of the conduit of the gas conduit 12. In the preferred embodiment of the present invention, the diameter of the pipe is approximately 25 millimeters. The width of the wall of the pipe in the preferred embodiment is between 3.5 and 4 millimeters. The width of the wall should be sufficient so as to support the set screw therein and prevent the set screw from being manipulated by force so as to be extracted from the threaded hole.

FIG. 2 shows the is a detailed view of the pipe 22. As can be seen, the threaded hole 26 is formed through the wall of the pipe 22 so as to open to the interior passageway 24. An inspection hole 34 is formed diametrically opposite to the threaded hole 26. The inspection hole 34 is unthreaded. Inspection hole 34 allows a user to properly observe the placement of the pipe 22 over the cap 20 and the portion 26 of the conduit 12.

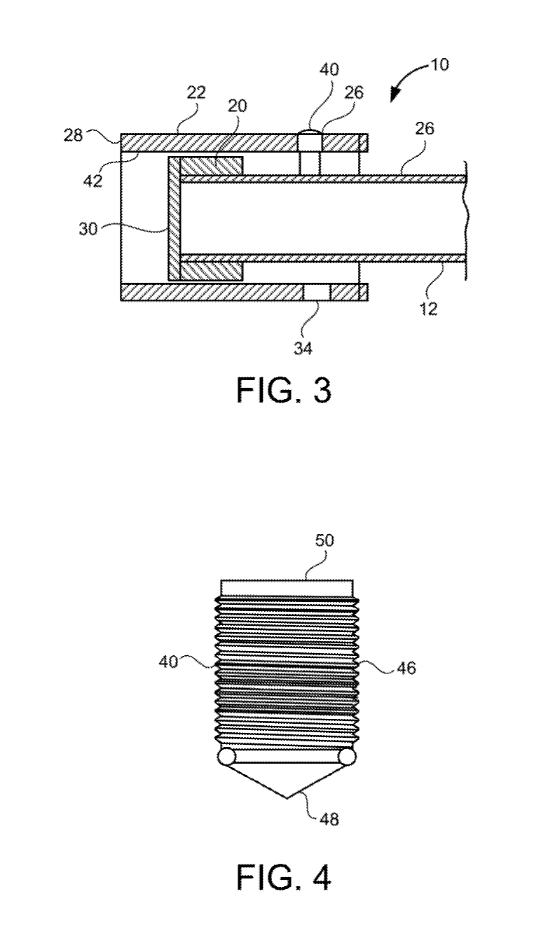

FIG. 3 shows the system 10 in which the pipe 22 is positioned over the cap 20 and over the portion 26 of the gas conduit 12. FIG. 3 shows that the end 28 of the pipe 22 extends outwardly a distance beyond the end 30 of the cap 20. FIG. 3 shows that the cap 20 is threadedly secured to the gas conduit 12. A set screw 40 is threadedly received in the threaded hole 26 and extends downwardly so as to bear against the exterior of the portion 26 of the gas conduit 12. The observation or inspection hole 34 is open and is directed toward the portion 26 of the gas conduit 12.

When the set screw 40 is properly installed in the threaded hole 26, the outer end of the set screw should be flush with the outer diameter of the pipe 22 or recessed slightly inwardly of the outer diameter of the pipe 22. The inner end of the set screw 40 will extend into the inner diameter of the pipe 22 so as to bear against the portion 26 of the gas conduit 12 or two extend into the space between the inner diameter of the pipe 22 and the portion 26 of the gas conduit 12 such that the inner end of the set screw extends inwardly of the outer diameter of the cap 20. Even though the inner end of the set screw 40 does not contact the portion 26 of the gas conduit, it is impossible to remove the pipe since these inner end of the set screw will interfere with the ability to slide the pipe off of the gas conduit 12 and over the cap 22. In the preferred embodiment of the present invention, the set screw will be formed of a stainless steel material and have a length of approximately 9.5 millimeters. In the preferred embodiment the present invention, the set screw 40 will have a ¼ inch×20 thread. The outer end of the set screw will have a center pin. This prohibits an Allen wrench from being used to remove the set screw.

Since the outer end of the set screw 40 is flush with the outer diameter of the pipe 20, it will prevent people from using vice grips or channel locks from grasping the set screw and manually turning the set screw. As such, it is virtually impossible to remove the pipe from the gas conduit without the use of a special tool.

FIG. 3 further shows that the inner diameter 42 of the pipe 22 it is slightly greater than the outer diameter of the cap 20 and is greater than the outer diameter of the portion 26 of the gas conduit 12. The set screw 40 is tightened so as to secure the pipe 22 in a location over the cap 20 and over the portion 26 of the gas conduit 12. As can be seen, if a pulling force is applied to the pipe 22, the extended set screw 40 will prevent the pipe 22 from being separated from its position over the cap 20 and over the portion 26 of the conduit 12. The pipe 22 and the set screw 40 can be suitably rotated without providing any ability to remove the pipe 22 from the portion 26 of the gas conduit 12 without the loosening and removal of the set screw 40.

FIG. 4 is an illustration of the set screw 40. The set screw 40 has an external threads 46 which will engage with the internal threads of the threaded hole 26 of pipe 22. The end 48 of the set screw 40 can be pointed or it can be blunt. FIG. 4 shows the end 48 as pointed. As such, the end 48 can easily bear against the exterior of the gas conduit 26 without penetrating the gas conduit. The outer end 50 of the set screw 40 will include a slot (to be described hereinafter) of a unique configuration so that the set screw 40 can only be secured and/or removed through the use of a special tool.

FIG. 5 shows the pipe 22 with the set screw 40 applied thereto. The end 48 of the set screw 40 is retracted so as to allow the pipe 22 to easily slide over the cap 20 and over the portion 26 of the gas conduit 12.

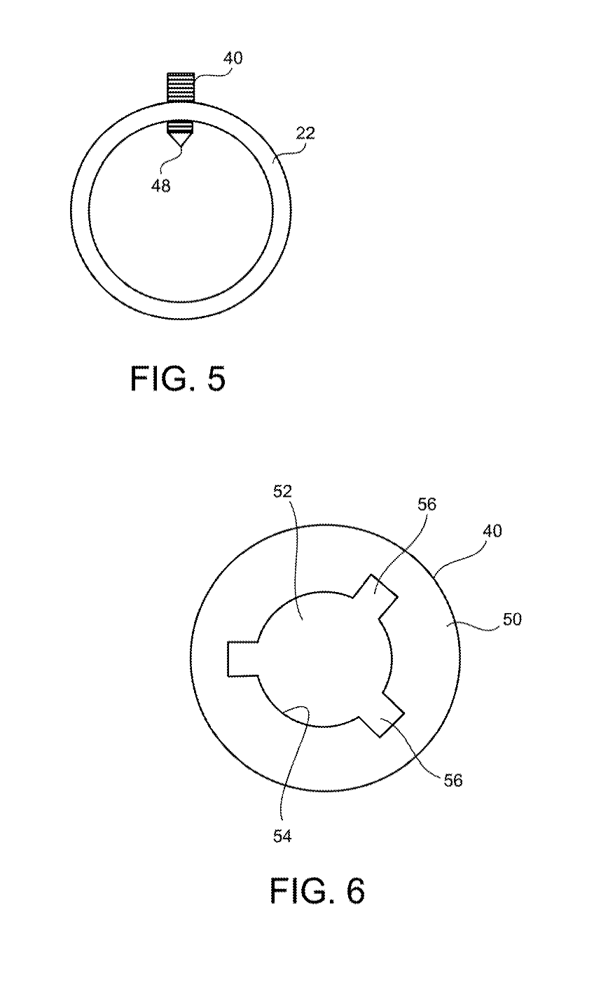

FIG. 6 shows the end 50 of the set screw 40. The slot 52 has a unique configuration so as to only accommodate a specialized tool. The configuration of the slot 52 has a center pin which prohibits the use of an Allen wrench. As such, in order to remove the pipe 22 from its position over the cap 20 and over the portion 26 of the gas conduit 12, a person desiring access must have the specialized tool.

The outer end 50 of the set screw 40 has a unique configuration. In one form, as illustrated in FIG. 2, it can be seen that the slot 52 has a generally circular area 54 with three rectilinear areas 56 extending radially outwardly of the circular area 54. A total of three rectilinear areas 56 are formed in the slot 52. Each of the rectilinear areas 56 is spaced from each other by approximately 120°. As such, in order to install or remove the device of the present invention, a tool must be used as a configuration that matches the slot 52. It is important to note that a wide variety of other slot configurations can be used in the present invention. The type of slot configuration shown in FIG. 4 is merely exemplary of this wide variety of slot configurations.

In the present invention, the tool is applied on to the set screw 40 so as to initially move the set screw 42 a retracted position. The pipe 22 can then slide over the cap 20 and over the portion 26 of the gas conduit 12. Once an observation is made through the inspection hole 34 that the pipe 22 overlies the portion 26 of the gas conduit 12, the tool can be re-applied to the slot 52 of the set screw 40 so as to rotate the set screw 40 within the threaded hole 26 of the pipe 22 in order to move the set screw toward the portion 26 of the gas conduit 12. Once the set screw contacts the gas conduit 12, the tool 60 can be removed from the slot 52. The device of the present invention effectively prevents tampering with the gas access valve of the refrigerant or air-conditioning system. The cap 20 can never be rotated as long as the pipe 22 is in this position. The pipe 22 can never be removed unless the specialized tool is utilized so as to rotate the set screw in order to loosen the set screw in order to remove the pipe from the cap 20.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A system for preventing unauthorized access to a gas, the system comprising:
a gas conduit having an end;
a cap affixed to said end of said gas conduit;
a pipe positioned over said cap and over a portion of said gas conduit, said pipe having a threaded hole formed through a wall of said pipe; and
a set screw threadedly secured in said threaded hole of said pipe, said set screw having an end bearing against said gas conduit.

2. The system of claim 1, said cap having an outer diameter that is greater than an outer diameter of said gas conduit, said pipe having an inner diameter slightly greater than an outer diameter of said cap.

3. The system of claim 1, said pipe having an end extending outwardly beyond an end of said cap opposite said gas conduit.

4. The system of claim 1, said pipe having an inspection hole formed through a wall of said pipe.

5. The system of claim 4, said inspection hole being diametrically opposite said threaded hole.

6. The system of claim 4, said inspection hole being unthreaded.

7. The system of claim 1, said set screw having a tool-receiving slot formed at an end thereof opposite the end of said set screw that bears against said gas conduit.

8. The system of claim 7, said tool-receiving slot having a configuration that does not receive us of an Allen wrench therein.

9. The system of claim 1, said pipe and said set screw being of a stainless steel material.

10. The system of claim 1, said set screw having an outer end flush with an outer diameter of said pipe or recessed inwardly of an outer diameter of said pipe.

11. The system of claim 1, said set pipe having a wall thickness of at least 3.5 millimeters.

12. The system of claim 1, said set screw being rotatable in said threaded holes so as to have the end thereof bearing against said gas conduit in one position and so as to have the end retracted to a position so as to provide clearance with said cap.

13. A device for preventing unauthorized access to a gas in an air-conditioning system, the air-conditioning system having a gas conduit with a cap affixed over an end thereof, the device comprising:
a pipe having a wall and an interior passageway, said interior passageway adapted to extend over the cap and a portion of the gas conduit, said pipe having a threaded hole extending through the wall of said pipe; and
a set screw threadedly received by said threaded hole of said pipe, said set screw being rotatable within said threaded hole and adapted so as to have an inner end extending into said interior passageway away from an inner wall of said pipe.

14. The device of claim 13, said pipe having an inspection hole formed through the wall of said pipe, said inspection hole communicating with the interior passageway of the pipe.

15. The device of claim 13, said pipe being open-ended.

16. The device of claim 13, said set screw having a tool-receiving slot formed at an outer end thereof.

17. The device of claim 16, said tool-receiving slot having a center pin that prevents receipt of an Allen wrench therein.
